(19) United States
(12) Patent Application Publication
(10) Pub. No.: US 2001/0051882 A1
(43) Pub. Date: Dec. 13, 2001

(54) Integrated care management system

(76) Inventors: Kevin M. Murphy, Derry, NH (US); Gregory M. Jungles, Clifton, VA (US)

Correspondence Address: BURNS DOANE SWECKER & MATHIS L L P, POST OFFICE BOX 1404, ALEXANDRIA, VA, 22313-1404, US

(21) Appl. No.: 09/820,736

(22) Filed: Mar. 30, 2001

Related U.S. Application Data
(60) Provisional application No. 60/143,549, filed on Jul. 13, 1999.

(51) Int. Cl. G06F 17/60; G06F 17/30

(52) U.S. Cl. 705/3; 707/104.1

(57) ABSTRACT

A method for matching clinical trials to qualified individuals in which the criteria for a plurality of clinical trials are stored, where each clinical trial describes a course of treatment for a particular illness or disease. Information is obtained from a user to determine whether the user is qualified for one or more of the clinical trials. The clinical trials for which the user qualifies is then presented to the user.

### CROSS-REFERENCE TO RELATED APPLICATION

This disclosure is based upon, and claims priority from, U.S. patent application Ser. No. 09/615,797 which is related to Provisional U.S. Patent Application No. 60/143,549, filed Jul. 13, 1999, the disclosures of which are incorporated herein by reference.

### FIELD OF THE INVENTION

The present invention is directed to health care, and more particularly to a system and method for matching individuals having various diseases and medical conditions to clinical trials for which they qualify.

### BACKGROUND OF THE INVENTION

In the treatment of individuals who have prolonged diseases, such as cancer, or other forms of chronic illness, great strides have been made in recent years. Many chronic illnesses and diseases are better understood through research and advanced technology, which traditionally has correlated to better treatment for those who suffer with these diseases and illnesses. However, further research and testing is still desirable for many of theses diseases and illnesses. Further, known treatments for these diseases and illnesses can be very painful or may not help certain individuals.

One manner in which the field of medicine has gained valuable knowledge of diseases, while experimenting with new treatments, is through the use of clinical trials. Clinical trials are developed and tested with individuals who qualify as patients for the specific objectives of the respective trials. In each clinical trial a certain type of individual with a defined disease or illness is required. Although new clinical trials are being developed every day, it is difficult to find individuals who qualify for the trials. Also, for those who wish to find new treatments for themselves, family or friends, it becomes extremely difficult to provide each of these people with the information on each clinical trial. Thus, there is a need to provide individuals and medical professionals with a central location from which they may access numerous clinical trials and information, or publish their own clinical trials. Further, there is a need for an easy and accurate way to match individuals to clinical trials and help others find a clinical trial without having to sort through all the clinical trials that are available.

It is an objective of the present invention to provide an integrated system for providing individuals access to information regarding clinical trials in a manner that is convenient and where specific information is easily obtainable. It is also an objective of the present invention to match individuals with chronic illnesses and diseases to clinical trials for which they qualify.

### SUMMARY OF THE INVENTION

In accordance with the present invention, individuals seeking new treatments for diseases or illnesses that they may suffer, or someone they know may be suffering from, are provided with a central location that allows the user to peruse numerous clinical trials or be matched to the clinical trials for which they qualify. This is achieved by a system that brings sponsors of clinical trials, professionals in the medical field, and individuals seeking clinical trials and information, together in an organized manner. Information is collected from individuals, sponsors and medical professionals in order to match individuals to clinical trials or provide them with pertinent information.

An embodiment of the invention describes a method and system for matching clinical trials to qualified individuals. A plurality of clinical trials are stored in a database, where each clinical trial describes a course of treatment for a particular illness or disease. Information is then gathered from individuals or users of the system to determine whether the user is qualified for one or more of the stored clinical trials. A list of all the clinical trials for which it was determined the user was qualified is then presented to the user.

In further features of the invention, information pertaining to certain clinical trials may be obtained, downloaded or printed for personal use. This information may be provided to a user's physician for consultation or the physician may provide this information to a patient.

In another feature of the present invention, registered users may be automatically notified about clinical trials that are newly added to the database of clinical trials for which the users may be a possible candidate, for example via encrypted messages. This eliminates the need for registered users to continually log into the system and have the system do a search for possible matches.

### BRIEF DESCRIPTION OF THE DRAWINGS

FIG. 1 is a block diagram depicting access alternatives to a clinical trial matching system in accordance with the present invention;

FIG. 2 is a diagram illustrating the flow of data from and to users of the matching tool and process;

FIG. 3 is a block diagram illustrating the various processes of the matching system;

FIGS. 4-10 are exemplary screen shots of various aspects of the matching system; and

FIG. 11 is a block diagram illustrating the logical data structure of the matching database.

### DETAILED DESCRIPTION

The present invention is directed to a system that provides an integrated approach to providing users of the system up-to-date information concerning clinical trials. The system further provides a user with operations that match themselves or another to a clinical trial for which they qualify. To facilitate an understanding of the features and operation of the present invention, it will be described hereinafter with specific reference to its use in the context of the treatment of a diseased patient. It will be appreciated, however, that the practical application of the principles which underlie the invention are not limited to this particular embodiment. Rather, the invention can be employed for a variety of different types of human afflictions for which a clinical trial is developed.

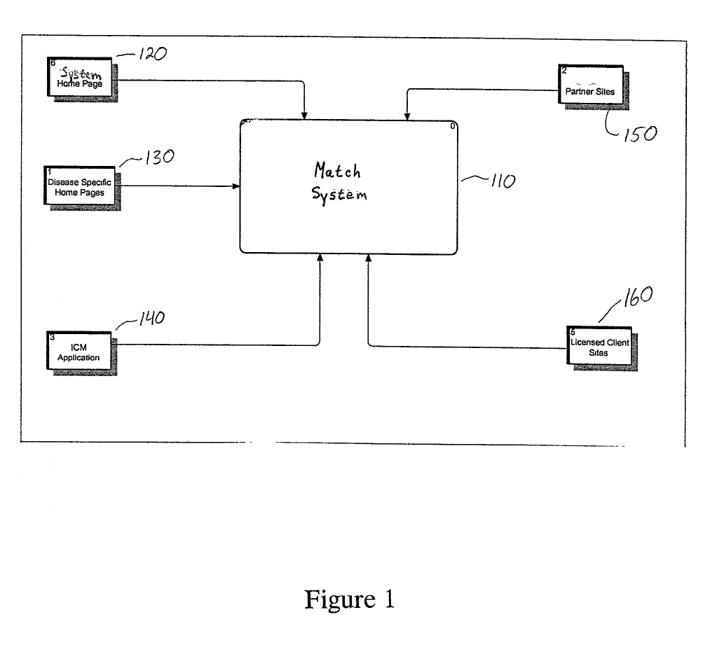

In a preferred embodiment of the present invention, the system is implemented as a stand alone Internet-based system. However, it should be noted that the system is not limited to being implemented as a stand alone system; the system may also be integrated into various existing or future technologies associated with health care. In the preferred embodiment, the system is a web-based interactive system. The system is comprised of several processes. FIG. 1 illustrates exemplary points of access for a matching system 110 that employs the principles of the invention. The matching system may be easily integrated into other systems that enable them to access the clinical trial data. Included in the access points are a system home page 120, a disease specific home page 130, integrated care management application 140, partner sites 150 and licensed client sites 160. An advantage to the integration abilities of the matching system is that it allows sites such as the disease specific sites 130 to have access to relevant data. Thus, an individual who might not look to the system home page may look to a home page in the chronic disease area and there find a link to the matching system.

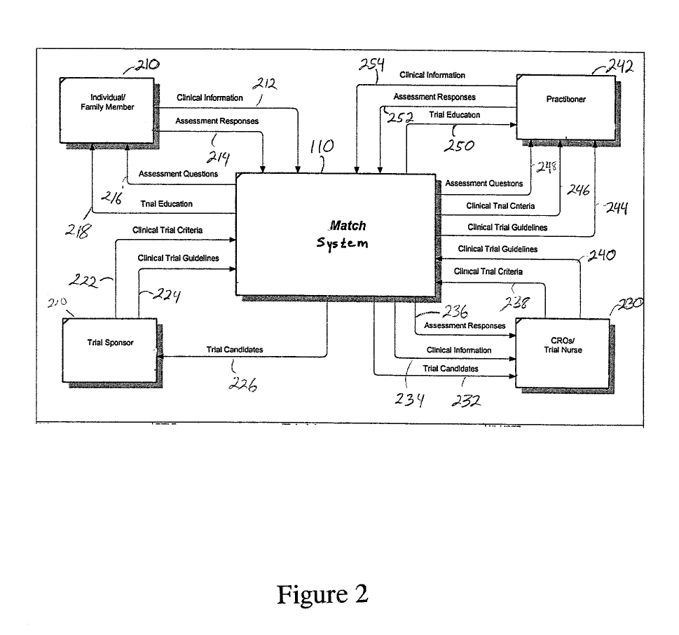

Once access has been obtained to the system, data may be transferred from and to the user. An exemplary diagram of the data flow is illustrated in FIG. 2. The user of the matching system may be an individual 210 seeking information or searching for clinical trials. A user of the system may also be a trial sponsor 220, practitioner 242 or CROs/trial nurse 230, or any other party that is necessary or interested in the system.

The sponsor 220 provides the system with all the new trials that are developed and ready for candidates. There may be a few to many sponsors that contribute to the database of clinical trials. Additionally, there may be numerous practitioners 242, CROs/trial nurses 230 and individuals/family members 210 who use and are linked to the system.

The matching system 110 includes a database of information that is used to match a trial candidate's particular conditions with the criteria of specific trials. The database includes a sequence of questions and defined answers that are based upon the criteria 222 and guidelines 224 supplied by the trial sponsors 220. Some of the questions and answers may be general in nature, and are designed to identify broad categories of trials for which a candidate may qualify. For instance, one question may ask for a candidate's age, and its defined answers may be selected ranges, e.g. 35-39, 40-44, 45-49, etc. Other questions are specific to the clinical details of a particular trial, and include the criteria for both inclusion into and exclusion from the trial. For example, one question for cancer-related trials may ask about the size of the candidate's tumor, and the defined answers may provide different ranges of sizes that are related to the criteria of one or more specific trials. Other questions directed to exclusion factors may ask whether the candidate has had prior chemotherapy or radiation treatments, and whether the cancer has metastasized at another site.

Hence, the questions and defined answers function to convert trial-specific criteria into a format that can be readily understood by members of the general public. These questions and answers can be prepared by a person who is skilled in the relevant disease which is the subject of the trial, such as an oncology nurse.

Once the database of questions and answers has been prepared, the matching process begins by obtaining information from an individual seeking a clinical trial. This information may come from, for example, the individual or from a family member 210 or from the practitioner 242 of the individual. Assessment questions 216 or 248 from the database are presented to the user in order to determine what clinical trial, if any, the individual in question may qualify for. The response to the assessment questions 214 and 252 are returned to the system 110. Preferably, the questions are organized and presented in an interactive manner, so that the particular defined answer that is selected in response to a given question determines the next question or series of questions to be presented as part of the assessment process. Alternatively, the user may provide the system 110 with clinical information 212 or 254 that would enable the system to identify clinical trials that correlates to the clinical information received.

Upon receiving the assessment response 214 or 252 and/or the clinical information 212 or 254, the system 110 may then use that information to match the potential patient to possible clinical trials. The assessment responses and clinical information are checked against the clinical trial information received. For instance, the responses to the questions can be used to construct a query which is presented to the database. For this purpose, the database is preferably constructed with a PDQ format, to provide for efficient searching in response to a query having a number of elements. If a match is found, meaning that the potential patient meets the criteria for the a particular clinical trial, this information is sent back to the trial sponsor 220 and the CROs/trial nurse 230 by way of trial candidate identifications 226 and 232. At the same time information pertaining to the trial itself is sent to the patient or family member 210, and/or practitioner 242. Trial criteria 246 and trial guidelines 244 may be sent directly to the practitioner 242. From this information, the practitioner 242 may determine if one of his/her patients qualifies for a clinical trial, at which point this information may be sent back to system 110 and passed on to the trial sponsor 220 or CROs/trial nurse 230.

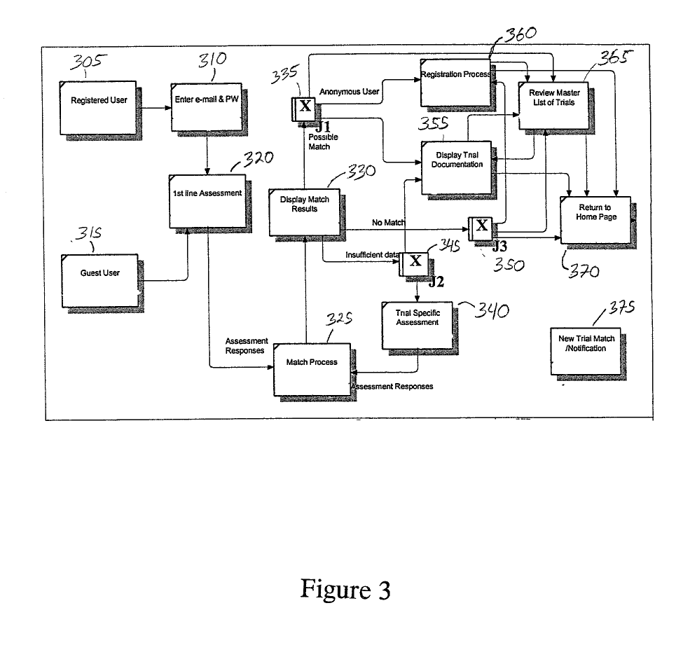

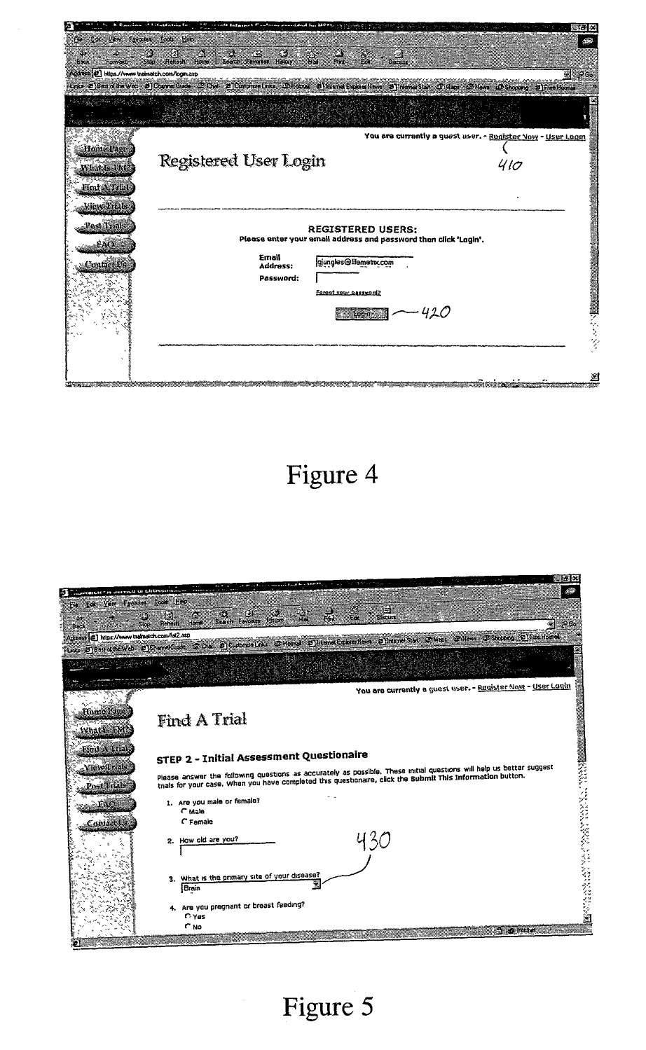

The matching system is comprised of multiple processes. Each of the individual processes are components that may be reconfigured to produce new and unique products. A more detailed description of the matching system and it processes is discussed hereinafter with reference to FIG. 3 and FIGS. 4-10. FIGS. 4-10 are exemplary screen shots that may be utilized on the matching system, for instance, as web pages. The first process appertains to the login of users in the system. There are two different logins, one for a registered user 305 and another for a guest user 315. The guest user 315 logs in as a guest and does not have to provide additional information. A registered user logs in by providing an email address and password 310. A screen shot of the registered user login is shown in FIG. 4. After entering the email address and password in the appropriate places, the user may click the login button 420 which calls up the next screen. If a user is not registered, the user may click on the Register Now button 410 at which point information is taken from the user and the user becomes registered. It should be noted that any type of information that distinguishes one user from another may be used as a registered user's login data.

After a user is logged in, an initial assessment 320 is prompted. The initial assessment 320 is comprised of a short questionnaire that is intended to gather information that will immediately narrow the list of trials for which the user may be a potential candidate. Different assessments may be set up by disease type in order to obtain the most relevant information. Generally, the initial assessment 320 gathers information about the specific condition for which the match process should search, for as well as basic demographic information such as age, gender and geographic region. FIG. 5 is an exemplary screen shot of the initial assessment questionnaire. Some of the questions, such as Question 3 in this example, include a drop-down menu 430 of the answers which have been predefined for the particular question. In this case, the answers define general categories of disease sites, e.g. brain, breast, lung, etc. The questions may vary according the different type of information necessary to accurately match a candidate to a clinical trial. The match process 325 constructs a query from the answers to assessment questions, which is applied to match criteria defined for each trial. If all criteria are met, a possible match is returned 330. If some, but not all of the criteria are met and no criteria are eliminated by the answers to exclusion questions, then a match result of “insufficient data” is rendered. At this point, the user may proceed to an assessment that is specific to a particular clinical trial, view documentation about a specific trial, view a list of all trials listed in the system database, or register for additional services.

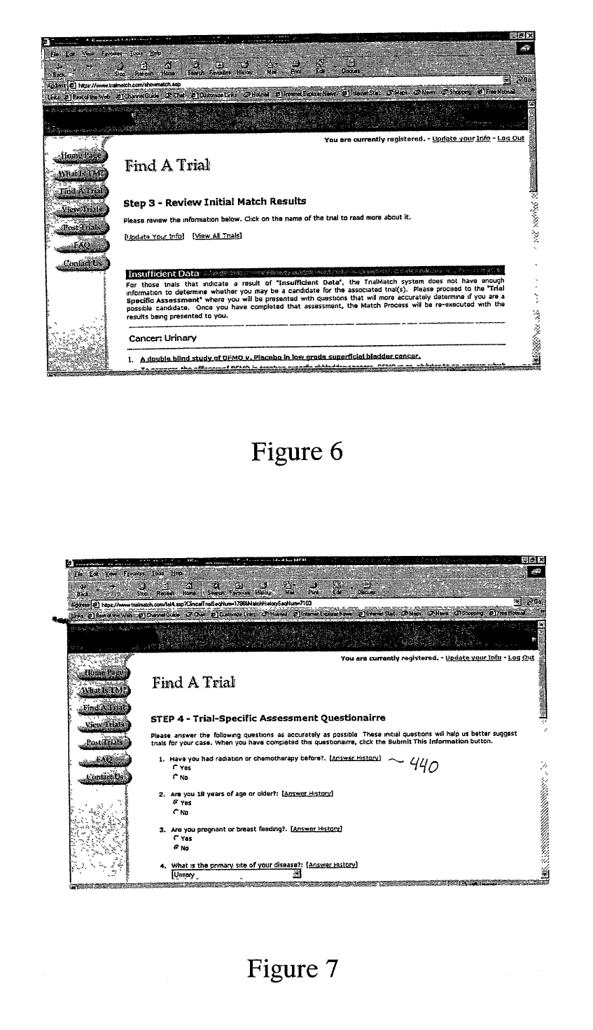

Only the trials that match the user or require more information are displayed for viewing by the user. FIG. 6 is an exemplary screen shot of initial match results corresponding to the initial assessment 320. Information pertaining to the matched clinical trials is displayed on this page. The user has the option to click on any of the matched clinical trials, to display more information about that trial. If additional information is needed beyond the information already provided in the initial assessment 320, then the trial may indicate that more data is needed by stating that there is “insufficient data”.

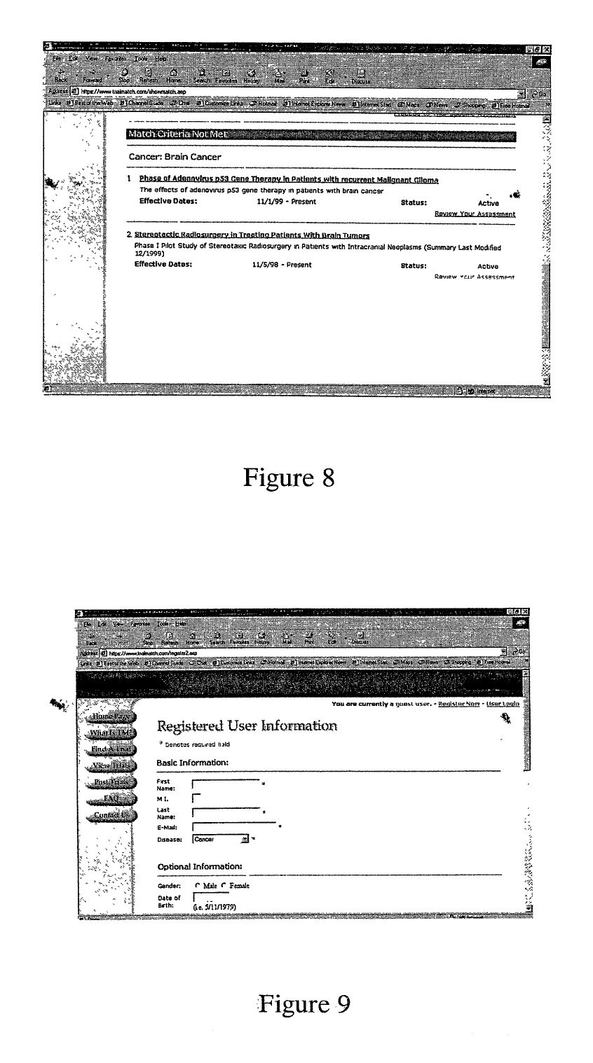

If the match process indicates that there is insufficient data to determine whether the person is a candidate for a particular trial, then the user may proceed to the trial specific assessment 340. At the trial specific assessment 340 the user is prompted with a series of additional questions designed specifically to assess the user's eligibility to participate in the selected trial. This questionnaire is comprised of more detailed questions than those asked in the initial assessment 320. Specifically, the questionnaire may ask questions concerned with the medical history and clinical conditions of the diseased person. If a question is asked that was previously answered in earlier questionnaires, then that answer is automatically displayed. An additional feature of the trial specific assessment is the answer history button 440, as shown in FIG. 7. This button allows the user to look at the history of the answers that were provided to a specific question. Once all the questions have been answered, the user may click the update button which stores their answers and starts the match process 325. At this point a new set of match results 330 may be displayed. The match results presented are the same as the first set of match results. However, if a prior match had resulted in a “possible match” or “insufficient data” condition and the current responses definitely exclude the user as a match, then that trial may appear under the heading of “Match Criteria Not Met”. FIG. 8 is an exemplary screen shot of the match results 330 showing two clinical trials in which, after the second assessment, the candidate no longer meets the criteria.

The user has a second option when a notice of insufficient data is returned in response to the initial assessment 320. Rather than answer the trial-specific questions, the user may display the trial documentation 355 for any clinical trial that was returned. Therefore, the user may obtain additional information about the trials in which the user may be a possible candidate.

From the displayed match results 330 there are several other options that a user may wish to pursue. If no match is found the user has three options. From junction 350, the user may return to the home page 370, review a master list of clinical trials 365 and/or begin the registration process 360 if not already registered. If a possible match was identified in which further data is not required, at junction 335 the user may display that trial documentation 355, review the master list of trials 365 and/or start the registration process 360.

When a user chooses to begin the registration process 360, that user may need to enter personal information. The personal information collected may include name, address, telephone number and email address. However, additional information about the user may also be collected. In a preferred embodiment, the email address is used as the user name. The user name is the name used when logging in as a registered user. During the collection of information the user will also be prompted to submit a password. This password will be used in conjunction with the user name to allow access to the matching system as a registered user. FIG. 9 is an exemplary screen shot of a registered user information page. FIG. 9 is an example of how information pertaining to the registered user may be obtained.

The registered user information collected is attached to the medical history which was collected as part of the assessment questionnaires 320 and 340. Periodically the matching system can run the assessment information against the trial database to determine if the diseased person matches the criteria of new trials that have been submitted. If the information indicates that there is a possible match, a message may be sent to the registered user that provides that user with information about the matched trials.

As a registered user, an individual may click on the registered user icon when revisiting the system homepage. Users may be prompted to enter an email address and password at which point they may gain access to their personal folders. A user may cancel registration at any time. If a user forgets a password, he or she may request that it be e-mailed to them, thereby eliminating the need for the user to register again. To maintain registered status a user may be required to return periodically to update and review their records. If a user does not perform these periodic updates and reviews, they may be taken off registered status and the automatic notifications may discontinue. In an embodiment of the present invention an email message will be sent to all active registrants whose accounts are near expiration. The message may include hyperlink and/or address to the user-specific information page within the matching system, so that they can resubmit or confirm their medical history information. From the registration process 360, the user may review the list of master trials 365 or return to the system homepage 370.

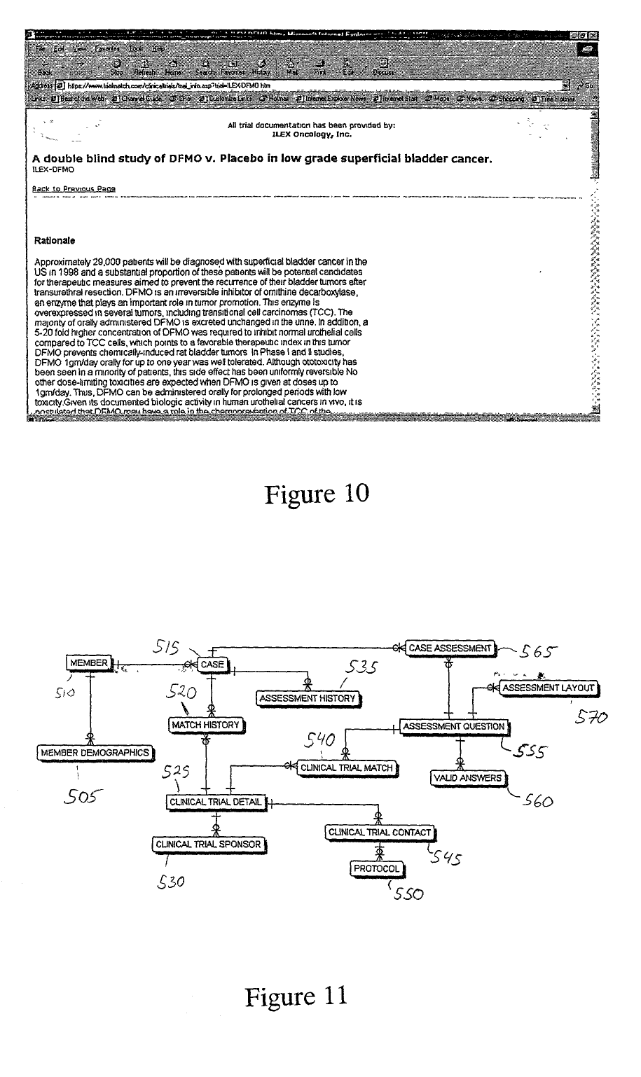

The trial documentation display 355 provides a user with the ability to view a document that may include a description of the trial, criteria for the trial, protocol number, trial sponsor and contacts. It should be noted that other information pertaining to the clinical trial may also be provided to the user. All this information is preferably available in a printable format as well, so that it can be printed and presented to the user's current physician. FIG. 10 is an exemplary screen shot of displayed information about a particular clinical trial. The displayed data provides users with enough information to determine if they would qualify for this particular trial or if the trial interests them. If the trial interests the user and it has been determined that they may be a potential candidate, then the user can contact the trial sponsor directly in order to participate in the clinical trial. Thus, the individual engaging in the trial may have a direct line of communication with the sponsors.

The master list of trials 365 contains all clinical trials in the matching system. Therefore a user may peruse the list of trials and the information that it contains in order to find a specific trial or a clinical trial that is of interest. After completing the review of the master list of trials 365, the user may return to the homepage 370 or return to previously viewed areas, such as the registration process 360 or trial display information 355.

The matching system may be employed as a web based system for use on the Internet. In order to provide the security for individuals using the matching system and particulary those individuals who enter information, the system preferably employs the use of encryption technologies, for example, 128-bit encryption. Along with the encryption, no identifying information is retained within the system, unless authorized by the user through the registration process. Being available on the Internet allows the system to be accessible to a wide variety of people across the world. The system may be set up to be accessible through various host sites. An embodiment of the present invention allows the system to be connected to an integrated care management system of the type described in application Ser. No. 09/615,797. This allows those users of the integrated care management system easy access to clinical trial information provided by the matching system. It also provides a pool of individuals against which the criteria for specific trials can be compared, to identify possible candidates.

FIG. 11 illustrates the logical data structure of the system database. The member table 510 may include the list of all registered users and members. The member demographics table 505 may include all data associated with the registered users. This data corresponds to the users/members stored in member table 510. The case table 515 may contain information concerning the individual cases surrounding different diseases and illnesses. Information pertaining to these individual cases are contained in the case assessment table 565. The questions that are used in the assessments for the different diseases and illnesses are stored in the assessment question table 555. The predefined answers to those questions are contained in the valid answers table 560. The assessment layout table 570 contains the proper layouts for the many different assessments. The information pertaining to the clinical trials are stored in the clinical trial detail table 525, clinical trial sponsor table 530 and clinical trial contact table 545. The match history table 520 contains the prior matches that were made between users and clinical trials. The assessment history table 535 contains the prior answers given and questions asked in each assessment taken for each user. The clinical trial match table 540 holds the clinical trials that match a user after the user has provided information in one of the assessments.

While this invention has been described in conjunction with exemplary embodiments outlined above, it is evident that many alternatives, modifications and variations will be apparent to those skilled in the art. Accordingly, the exemplary embodiments of the invention may be made without departing from the spirit and scope of the invention.

What is claimed is:

1. A method for matching specific clinical trials to qualified individuals, comprising the steps of:
storing criteria for a plurality of clinical trials, where each clinical trial describes a course of treatment for a particular illness or disease;
obtaining information from a user;
determining whether the user is qualified for one or more clinical trials by comparing the obtained information with the stored criteria; and
presenting the user with information regarding the clinical trials for which it was determined the user was qualified.

2. The method of claim 1 wherein the step of obtaining information includes an initial assessment used in determining the qualification of the user for a particular clinical trial.

3. The method of claim 1 further including the step of storing specific assessment questions for each particular disease and trial, and wherein these questions are presented to the user subsequent to answering initial assessment questions.

4. The method of claim 1 further includes the step of obtaining clinical trial information from clinical trial sponsors.

5. The method of claim 2 further including storing the responses to the assessment questions.

6. The method of claim 1 further including receiving new clinical trials wherein the user is notified of the new clinical trial for which the user is determined to be a possible candidate.

7. A computer readable medium containing a program which executes the following steps:
obtaining information from a user to assess whether the user is a match for a particular clinical trial;
selecting clinical trials for which the user fits the criteria of being a possible match; and
presenting the user with the selected clinical trials.

8. The method of claim 7 wherein the step of obtaining information includes an initial assessment used in determining the qualification of the user for a particular clinical trial.

9. The method of claim 7 further including the step of storing specific assessment questions for each particular disease and trial and wherein these questions are presented to the user subsequent to answering initial assessment questions.

10. The method of claim 7 further includes the step of obtaining clinical trial information from clinical trial sponsors.

11. The method of claim 8 further including storing the responses to the assessment questions.

12. The method of claim 7 further including receiving new clinical trials wherein the user is notified of the new clinical trials for which the user is determined to be a possible candidate.

13. A clinical trial matching system, comprising:
a memory that stores criteria for a plurality of clinical trials, where each clinical trial describes a method of treatment for a particular illness or disease;
a user interface by which a user may enter data which provides information in order to match the user to a specific clinical trial for which the user has a high probability of qualifying;
a selection component which selects the clinical trials to which the user is a possible match; and
a presentation component which presents the selected clinical trial to the user.

14. The system of claim 13 further comprising a relational database that stores information relating to at least one of user information, clinical trials, assessment questions, and clinical trial matches.

15. The system of claim 13 wherein the system is a web based system.

16. The system of claim 13 wherein the system is capable of integrating into other health care related systems.

17. The system of claim 13 wherein information for matching a user to a clinical trial is obtained from a series of assessment questions presented to the user.

18. The system of claim 17 wherein said questions contained predefined answers that identify conditions for inclusion or exclusion from a specific trial.
